(19) United States
(12) Patent Application Publication
(10) Pub. No.: US 2003/0040829 A1
(43) Pub. Date: Feb. 27, 2003

(54) Method, device and system for producing a replica of an assembly broad, especially, a replica of an assemply board for producing a cable harness that duplicates a master cable harness

(76) Inventors: Alain Coquelet, Quevy (BE); Pierre Dupont, Jurbise (BE); Daniel Vienne, Estaimpuis (BE)

Correspondence Address: LERNER AND GREENBERG, P.A., Post Office Box 2480, Hollywood, FL, 33022-2480, US

(21) Appl. No.: 10/217,226

(22) Filed: Aug. 12, 2002

Related U.S. Application Data
(63) Continuation of application No. PCT/DE01/00501, filed on Feb. 9, 2001.

(30) Foreign Application Priority Data
Feb. 11, 2000 (DE) 100 06 233.4
May 3, 2000 (DE) 100 21 561.0

(51) Int. Cl. G06F 19/00

(52) U.S. Cl. 700/117; 29/825

(57) ABSTRACT

A device for duplicating an assembly board includes a master assembly board on which assembly components for a master cable harness are disposed. A displaceably guided component including a scanning device, which is disposed above the master assembly board, and a replica of the assembly board, which is connected in a fixed manner to the master assembly board, enables the positions of the assembly components on the master assembly board to be transferred to the replica of the assembly board. Alternatively, the positions can be stored as data and transferred onto a replica of the assembly board. A method and a system for duplicating an assembly board are also provided.

### CROSS-REFERENCE TO RELATED APPLICATION

This application is a continuation of copending International Application No. PCT/DE01/00501, filed Feb. 9, 2001, which designated the United States and was not published in English.

### BACKGROUND OF THE INVENTION

Field of the Invention

The invention relates to a method, a device, and a system for producing a replica of an assembly board, especially, a replica of an assembly board for producing a cable harness that duplicates a master cable harness for a motor vehicle.

During the manufacture of electric equipment for motor vehicles, the problem arises that the cable harnesses required for such a purpose are needed at different locations and in different numbers. In such a case, an overall vehicle cable harness generally includes a plurality of cable harnesses that, depending on the equipment level, vary or are missing altogether.

Cable harnesses are, for the most part, mounted by manual labor on assembly boards. Such assembly boards are needed appropriately numerously and at different locations, great requirements being placed on the accuracy with which the cable harnesses are produced on the assembly boards, because of the high operational reliability to be met by the electrics and the restricted installation space in the vehicle.

### SUMMARY OF THE INVENTION

It is accordingly an object of the invention to provide a method, device and system for producing a replica of an assembly board, especially, a replica of an assembly board for producing a cable harness that overcomes the hereinafore-mentioned disadvantages of the heretofore-known devices and methods of this general type and that provides assembly boards on which a predefining master cable harness can be duplicated precisely.

With the foregoing and other objects in view, there is provided, in accordance with the invention, a method for producing an assembly board replica, including the steps of defining positions of mounting components for producing a master cable harness on a master assembly board, registering the defined positions of the mounting components on the master assembly board with a copying device, and transferring the registered positions of the mounting components to a replica of the master assembly board.

The method according to the invention is simplified in terms of its ability to be carried out and is very secure against faults.

By copying or transferring the positions of the mounting components from the master assembly board to the replica of an assembly board, the electric circuit modules to be produced on the replica of an assembly board are then “duplicates” of the circuit module mounted on the master assembly board. The production of the replicas of an assembly board, which is needed repeatedly, is simple and cost-effective.

In accordance with another mode of the invention, the transfer of the registered positions of the mounting components to the replica of the master assembly board are carried out with the master cable harness mounted on the master assembly board.

There is also provided a method in which the transfer from the master assembly board to replicas of an assembly board is carried out by direct, purely mechanical transfer.

In accordance with a further mode of the invention, the replica of the master assembly board is fitted in a physically fixed relationship with respect to the master assembly board and the transfer of the registered positions of the mounting components is carried out with an intrinsically rigid copying device movable in the same way relative to the master assembly board and the replica of the master assembly board.

In accordance with an added mode of the invention, the defined positions are stored in a memory and the defined positions are read out and transferred to the replica of the master assembly board.

The positions picked off from the master assembly board are converted into electronic data and are then available for reliable and convenient transfer to an extremely wide range of geographic locations and an extremely wide range of devices so that the positions corresponding to the data can be transferred by suitable devices to a replica of an assembly board to be produced.

In accordance with an additional mode of the invention, type-of-position data is added to the defined positions.

In accordance with yet another mode of the invention, type-of-position data related to the defined positions is defined, the type-of-position data is registered, and the type-of-position data is transferred with the registered positions to the replica of the master assembly board.

With the objects of the invention in view, there is also provided a method for producing an assembly board replica for producing a cable harness duplicating a master cable harness for a motor vehicle, including the steps of defining positions of mounting components for producing the master cable harness on a master assembly board, registering the defined positions of the mounting components on the master assembly board with a copying device, and transferring the registered positions of the mounting components to a replica of the master assembly board.

With the objects of the invention in view, there is also provided a device for producing a replica of an assembly board, including a master assembly board, mounting components for an assembly of a master cable harness, the mounting components disposed on the master assembly board, an assembly board replica for receiving other mounting components to produce a cable harness duplicating the master cable harness, the assembly board replica rigidly connected to the master assembly board, an intrinsically rigid component movably guided relative to the master assembly board and the assembly board replica, a copying device and a scanning device each disposed on the rigid component to have movement of the scanning device over the master assembly board correspond to movement of the copying device over the assembly board replica, the scanning device connected to the copying device, and the scanning device registering a position of a location on the master assembly board and transmitting the registered position to the assembly board replica through the copying device.

There is also provided a device, operating in the manner of a pantograph, for transferring positions from the master assembly board to the replica of an assembly board.

With the objects of the invention in view, there is also provided a device for producing a cable harness duplicating a master cable harness for a motor vehicle, including a master assembly board, mounting components for an assembly of a master cable harness, the mounting components disposed on the master assembly board; an assembly board replica for receiving other mounting components to produce a cable harness duplicating the master cable harness, the assembly board replica rigidly connected to the master assembly board, an intrinsically rigid component movably guided relative to the master assembly board and the assembly board replica, a copying device and a scanning device each disposed on the rigid component to have movement of the scanning device over the master assembly board correspond to movement of the copying device over the assembly board replica, the scanning device connected to the copying device, and the scanning device registering a position of a location on the master assembly board and transmitting the registered position to the assembly board replica through the copying device.

With the objects of the invention in view, there is also provided a device for replicating mounting components assembling a master cable harness on a master assembly board to an assembly board replica having other mounting components and a cable harness duplicating the master cable harness, the assembly board replica being rigidly connected to the master assembly board, including an intrinsically rigid component movably guided relative to the master assembly board and the assembly board replica, a copying device and a scanning device each disposed on the rigid component to have movement of the scanning device over the master assembly board correspond to movement of the copying device over the assembly board replica, the scanning device connected to the copying device, and the scanning device registering a position of a location on the master assembly board and transmitting the registered Position to the assembly board replica through the copying device.

With the objects of the invention in view, there is also provided a system for producing a replica of an assembly board, including a master assembly board having mounting components at defined positions of the master assembly board, the mounting components assembling a master cable harness, an assembly board replica, a scanning device registering the defined positions and producing position data corresponding to the registered positions, a storage device connected to the scanning device and storing the registered position data, and a transfer device connected to the storage device and effecting transfer of the stored position data to the assembly board replica.

The basic construction of a system in which the transfer of positions on a master assembly board to a replica of an assembly board is carried out with the aid of electronic data processing.

With the objects of the invention in view, there is also provided a system for producing a cable harness duplicating a master cable harness for a motor vehicle, including a master assembly board having mounting components at defined positions of the master assembly board, the mounting components assembling the master cable harness, an assembly board replica, a scanning device registering the defined positions and producing position data corresponding to the registered positions, a storage device connected to the scanning device and storing the registered position data, and a transfer device connected to the storage device and effecting transfer of the stored position data to the assembly board replica.

There is also provided a device, contained in the system for recording the position data of mounting parts on the master assembly board and storing the data in a storage device.

In accordance with yet a further feature of the invention, there is also provided a position data producing device for producing position data corresponding to the defined positions of the mounting components, the position data producing device having position transmitters for generating position signals corresponding to a respective one of the defined positions, a component displaceable over a surface of the master assembly board and interacting with the position transmitters, a carriage connected to the component, a storage device for storing the position data corresponding to the position signals, and a triggering device controlling an action of reading the position data into the storage device when the carriage has reached a position corresponding to a position of one of the mounting components.

In accordance with yet an added feature of the invention, there is provided a type-of-position marking device connected to the storage device and storing type-of-position data into the storage device.

The device is constructed for transferring position data stored in a storage device to a replica of an assembly board.

In accordance with yet an additional feature of the invention, there are also provided position transmitters for generating position signals corresponding to each respective position of the mounting components, a component displaceable over an area of the assembly board replica and interacting with the position transmitters, and a control device connected to the component and controlling a position of the component dependent upon the stored position data in the storage device.

In accordance with again another feature of the invention, the component is a carriage, a drive motor is connected to the carriage and to the control device, the drive motor moves the carriage respectively in one of two directions at right angles to one another; and the control device controls the drive motor to move the carriage into positions corresponding to the stored position data.

In accordance with again a further feature of the invention, the component is a carriage, two drive motors are connected to the carriage and to the control device, the drive motors each move the carriage respectively in one of two directions at right angles to one another, and the control device controls the drive motors to move the carriage into positions corresponding to the stored position data.

The positions to be recorded on the master assembly board and their environment can advantageously be made visible.

In accordance with again an added feature of the invention, the component has a light source for illuminating a portion of the master assembly board and a camera for recording the illuminated portion of the master assembly board, and a screen reproduces an image recorded by the camera.

It is advantageous to mark the locations on the replica of an assembly board corresponding to the positions on the master assembly board immediately by a marking device contained relative to the replica of an assembly board.

In accordance with again an additional feature of the invention, the rigid component is a marking device for marking locations on the assembly board replica corresponding to respective locations on the master assembly board.

In accordance with still another feature of the invention, the carriage is a marking device for marking locations on the assembly board replica corresponding to respective locations on the master assembly board.

Different mounting tasks can be carried out automatically.

In accordance with still a further feature of the invention, the type-of-position marking device marks the assembly board replica dependent upon the type-of-position data.

In accordance with still an added feature of the invention, there is provided a storage device connected to the scanning device and storing the registered position data, the marking device being a type-of-position marking device connected to the storage device and storing type-of-position data into the storage device, and the type-of-position marking device marking the assembly board replica dependent upon the type-of-position data.

Cable harnesses that are produced on the replica of an assembly board can, themselves, contain circuit modules in addition to the cables so that the cable harnesses are constructed in the form of prefabricated circuit modules.

In accordance with a concomitant feature of the invention, the master cable harness and the cable harness have cables and are fitted with circuit modules at least partly connected without plugs to ends of the cables and are fixed on the master assembly board by the mounting components.

The replicas of an assembly board produced in accordance with the invention are suitable for the production of prefabricated electric circuit modules of many kinds. These include not only cable harnesses but also at least partly equipped cable harnesses. In such a case, the circuit modules and the cables form a prefabricated subassembly or a prefabricated module, in which the cables are advantageously connected directly to terminals of the circuit modules or plugs, for example, by soldering. The electric circuit so constructed is supplied as a finished circuit module, for example, to an assembly line for automobiles, in order to be incorporated in the latter, the provision of new plug-in connections being largely superfluous. Such completely prefabricated circuits, which contain circuit modules and their cabling, are suitable for an extremely wide range of applications, for example, for occupant protection circuits, such as airbag circuits, but also for circuits that, for example, belong to an electronic driving stability system that includes different sensors, whose output signals are used in a control device for activating the wheel brakes, a power setting element of the engine, and so on, or for further circuits.

Other features that are considered as characteristic for the invention are set forth in the appended claims.

Although the invention is illustrated and described herein as embodied in a method, device and system for producing a replica of an assembly board, especially, a replica of an assembly board for producing a cable harness, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a diagrammatic plan view of a device for duplicating a master assembly board according to the invention;

FIG. 2 is a diagrammatic plan view of a master assembly board and a replica of an assembly board according to the invention with an incomplete structure of a copied circuit;

FIG. 3 is a diagrammatic plan view of a device for producing stored position data according to the invention; and

FIG. 4 is a diagrammatic plan view of a device for transferring stored position data to a replica of an assembly board according to the invention.

### DESCRIPTION OF THE PREFERRED EMBODIMENTS

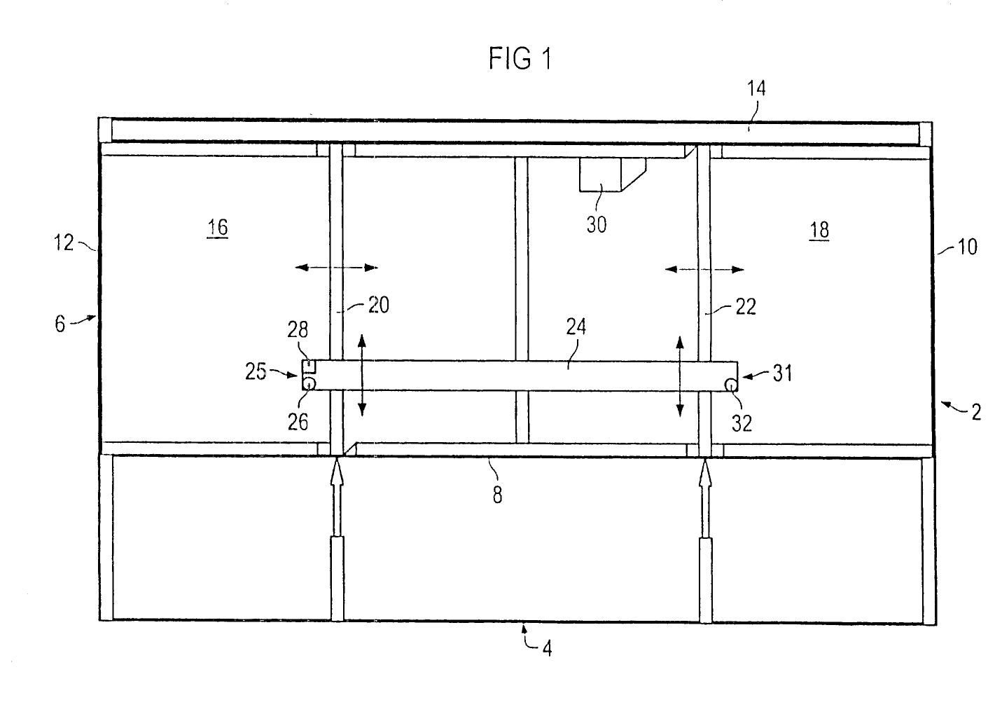

Referring now to the figures of the drawings in detail and first, particularly to FIG. 1 thereof, there is shown a device for producing an assembly board having a stable frame 2, which includes a subframe 4, for example, standing on the floor, and an upper frame 6 disposed on the subframe 4.

The subframe 4 ends at the top in a longitudinal beam 8 that, at the same time, forms the lower boundary of the upper frame 6 and that, together with lateral beams 10 and 12 and an upper longitudinal beam 14 connecting these, forms the upper frame 6.

According to FIG. 1, a master assembly board 16 is fixed rigidly to the left-hand half of the upper frame 6, while the right-hand half of the upper frame 6 holds a replica of an assembly board 18 rigidly. The assembly boards 16 and 18 are constructed, for example, by grid perforated plates with an adequately fine grid so that holding pins or other mounting components can be fitted at respectively predetermined points. Alternatively, the assembly boards 16 and 18 can also be constructed with surfaces that, in the manner of pin boards, readily permit the insertion of holding pins or the like.

Alternatively, the assembly boards can also be formed by simple boards or metal sheets, in which holes can be formed for the fitting of mounting components.

On the upper longitudinal beam 14 and the lower longitudinal beam 18, two vertical rails 20 and 22 are guided so that they can move in the manner of a carriage, for example, by roller guides or carriages. On the two rails 20 and 22, a bar 24 is guided in a similar way such that it can move vertically, so that the bar 24 can be displaced in the vertical and horizontal direction, that is to say, in the X-Y direction, relative to the assembly boards 16 and 18 while maintaining its horizontal attitude. The displacement of the bar 24 can be carried out manually or through a control system, for example, driven by machine with a control knob.

The left-hand end of the bar 24 according to FIG. 1 is constructed as a scanning device 25 having a Laser light source 26, which aims a bundle of light onto the master assembly board 16, and a camera 28 that registers the area of the master assembly board 16 illuminated by the laser light source 26. The image recorded by the camera 28 is visible on a screen 30 that, for example, is fitted to the upper longitudinal beam 14 or can also be fitted directly to the bar 24.

The right-hand end of the bar 24 is constructed as a copying device 31 and has a light source 32 that illuminates an area of the replica of an assembly board 18.

When the bar 24 is moved, a spot of light illuminated by the light source 32 moves on the replica of an assembly board 18 along a path that is identical to the path that is illuminated on the master assembly board 16 by the light source 26.

The transmission of movement between the light source 26 and the light source 32, therefore, acts in the same way as a pantograph.

Together with the scanning device 25 and the copying device 26, the bar 24 forms copying device, with which the replica of an assembly board 18 can be produced as a duplicate or a copy of the master assembly board 16.

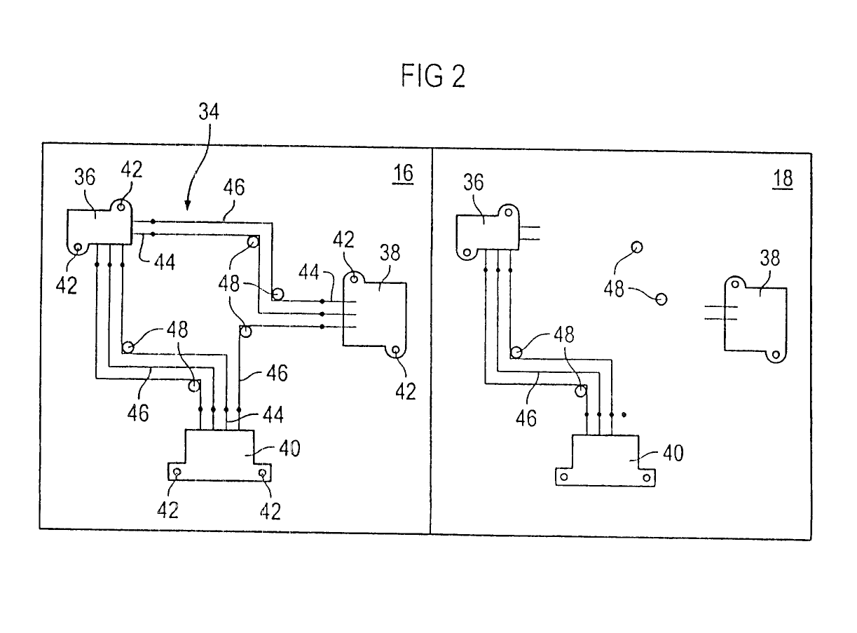

In the following text, the function of the device according to FIG. 1 will be explained by using FIG. 2.

FIG. 2 shows a plan view of the master assembly board 16 and the replica of an assembly board 18.

Mounted on the master assembly board 16 is a complete master cable harness 34 forming a circuit module and including a circuit module 36, for example, a sensor module with integrated evaluation electronics, a circuit module 38, for example, a firing device for an airbag, and a circuit module 40, for example, a plug for connection to vehicle electronics. The circuit modules 36, 38, and 40 each have fastening eyes that are fixed with the aid of pins 42 fixed in the master assembly board 16.

The circuit modules 36, 38, and 40 each have connecting pins 44, which are connected electrically to cables 46, for example, flat ribbon cables, by the wires of the cables being soldered or welded or crimped to the connecting pins 44 or connected permanently and reliably to one another in another way. Mounting pins 48 introduced into the master assembly board 16 serve for the local fixing of the cables 46.

Mounting pins 48 can be provided that define a straight section of a cable, define a bend in a cable, and so on. A cable harness can include different lengths of cables that, with different numbers of wires, lead to different plugs, and so on.

When the master circuit 34 has been constructed or mounted on the master assembly board 16, the parallel-guided bar 24 with the scanning device 25 formed by the light source 26 and the camera 28 and the copying device formed by the light source 32 comes into use.

First of all, using the light source 26, a move is made to all those locations on the master assembly board 16 at which pins 42 or mounting pins 48 are fitted. These locations can be observed exactly on the screen 30, for example, the light source 26 projecting a crosshair with which it is possible to aim accurately at the location of the pin. When the respective pin is in the sights, the light source 32 marks a corresponding location or a corresponding point on the replica of an assembly board 18, which can be marked by hand or by an appropriate construction of the surface of the replica of an assembly board and switching on the light source 32 for a short time, or at which a pin or mounting pin can be fitted immediately. Thus, after moving to all the pins or mounting pins on the master assembly board, the respective locations on the replica of an assembly board 18 are marked or appropriate pins or mounting pins are fitted at the respective locations. The master circuit 34 can then be duplicated on the replica of an assembly board 18 marked and so constructed, FIG. 2 showing on the right the mounted circuit modules 36, 38, and 40, the circuit modules 36 and 40 already being connected to each other through the cable 46 and only the cable connecting the modules 36 and 38 and the cable connecting the circuit modules 40 and 38 still having to be fitted.

The device can be modified or supplemented in many and various ways.

The circuit modules can be omitted so that only cables forming a cable harness are mounted on the master assembly board to form a master cable harness. Here, the cables can be disposed in an extremely wide range of geometric ways to form a cable harness, for example, parallel to one another with different lengths, with branches, and so on.

The light source 32 used for copying can be formed by a powerful laser that, given appropriate construction, burns holes directly into the replica of an assembly board 18, into which holes the pins can then be inserted. In such a case, the light source 32 is in each case switched on only briefly when the light source 26 is over the respective object.

The bar 24 can be equipped with welding, soldering, or crimping devices, with the aid of which the cables can be connected to the connecting pins in the manner, for example, of the SME technique.

The mounting components can be of an extremely wide range of types and be simple holding pins, complicated multi-part hold-downs, and so on. The mounting components can be provided with devices for connecting individual cables and/or conductors of the cables to further modules.

A plurality of master cable harnesses or circuits can be constructed on a master assembly board, their positions being copied to the replica of an assembly board.

The entire device can be constructed, as in the case of pantographs, such that the duplicated circuits are not constructed to the same size as the master circuit but are larger or smaller. The bar 24 does not have to be driven by hand, but can be motor driven so that the device can be operated by remote control.

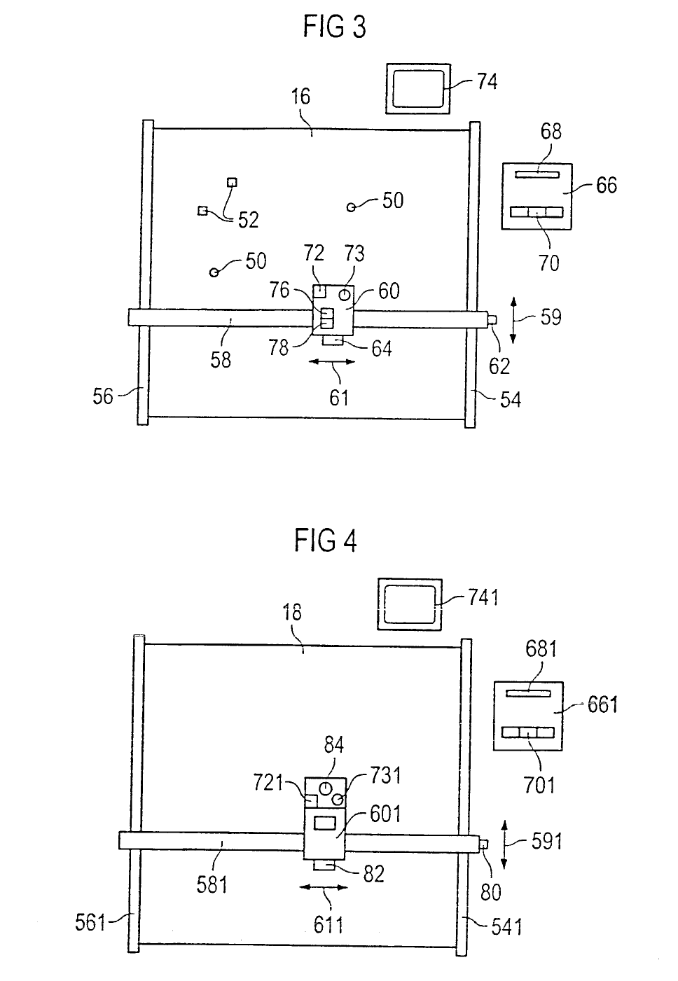

By using FIGS. 3 and 4; a system will be described in the following text in which the transfer of position data from a master assembly board to a replica of an assembly board takes place with the interposition of electronic storage of position data. In such a case, the master assembly board and the replica of an assembly board do not have to be disposed in a fixed physical relationship but can be far removed from each other.

FIG. 3 shows a master assembly board 16 with positions 50 and 52, the positions 50 corresponding to those of mounting pins 48 from FIG. 2, for example, and the positions 52 corresponding to those of pins 42. The positions 50 are illustrated as circles and signify, for example, circular holes into which the mounting pins 48 can be inserted. The positions 52 are illustrated as rectangular holes and correspond for example to correspondingly constructed ends of the pins 42. It goes without saying that the entire master cable harness according to FIG. 2 can be constructed on the master assembly board 16.

The master assembly board 16 is disposed between two lateral rails 54 and 56, which form rolling and guide tracks for a bar 58, which extends transversely over the master assembly board 16 and can be moved along the rails 54 and 56 in the direction of the double arrow 59. The bar 58 carries a carriage 60, which can be moved along the bar 58 in the direction of the double arrow 61.

The movement of the bar 58 along the rails 54 and 56 is registered by a position transmitter 62 that, for example, senses the rotation of a roller and generates a corresponding output signal that, as a position signal, indicates the position of the bar 58 in the vertical direction according to FIG. 3 and, therefore, the position of the carriage 60 relative to the master assembly board 16 in the vertical direction of the latter. In a corresponding way, a position transmitter 64 is fitted to the carriage 60, which indicates the position of the carriage 60 with respect to the master assembly board 16 in the horizontal direction of the latter according to FIG. 3. The position transmitters 62 and 64 are connected through non-illustrated lines to a control device 66 that contains a microprocessor with associated storage devices, which are not shown in detail. Reference numeral 68 designates a slot for the insertion of a non-illustrated data medium, for example, a floppy disk. Reference numeral 70 designates operating elements, which could also be formed by a keyboard.

The carriage 60 carries a camera 72, whose images can be reproduced through a screen 74 and can advantageously be stored in a non-illustrated memory belonging to the control device 66. To illuminate the part of the master assembly board 16 located underneath the carriage 60, use is made of a light source 73. The carriage 60 further has a trigger key 76 and a type-of-position key 78, which are connected to the control device 66 through non-illustrated lines.

The function of the configuration described above is set forth in the following text.

The carriage 60 is moved, for example, by hand, over the master assembly board 16, in each case the scene illuminated by the light source 73, located under the carriage 60 and recorded by the camera 72, being visible on the screen 74. The camera 72 is, for example, provided with a crosshair so that the position of the carriage 60 can be determined accurately. As soon as the crosshair of the camera 72 is located over one of the positions 50 or 52, the trigger key 76 is operated, whereupon the signals supplied by the position transmitters 62 and 64 are read in and stored by the control device 66 as position data. In addition to the trigger key 76, the type-of-position key 78 is operated, as a result of which, type-of-position data corresponding to the operation of the type-of-position key 78 are stored in the control device 66 in addition to the position data. It goes without saying that, depending on the number of different types of positions (two in the example illustrated), there may be a plurality of type-of-position keys. In addition to the position data, respective scene data or images recorded by the camera 72 can be stored.

In the aforementioned way, all the relevant data from the master cable harness 34 (FIG. 2) can be stored by the control device 66 in a memory belonging to the control device 66 and is available for further processing.

FIG. 4 shows a device for transferring position data and type-of-position data recorded by the device according to FIG. 3 to a replica of an assembly board 18 to be produced. For parts corresponding to components in the device according to FIG. 3, the same designations as those in FIG. 3 are used, but with a suffix “1.”

As distinct from the device according to FIG. 3, to drive the bar 581, a drive motor 80 configured, for example, as a switched stepping motor and, to drive the carriage 601, a drive motor 82 configured, for example, as a switched stepping motor are provided. The motors 80 and 82 are connected to the control device 661 through non-illustrated lines.

In addition, the carriage 601 according to FIG. 4 additionally has a focusing light source, for example, a powerful laser 84 (i.e., sufficiently powerful to perform the functions assigned thereto, such as aligning, marking, boring and/or cutting), which can be controlled by the control device 60 and for whose operation appropriate non-illustrated safety devices are provided.

The function of the device according to FIG. 4 is described in the following text.

It is assumed that the data relevant to the master circuit, stored in the control device 66 of FIG. 3, is to be transferred to a floppy disk or another data medium, for example, a CD, with additionally stored image data, the floppy disk being inserted into the slot 681 in the control device 661. A program stored in the control device 661 is then started with the aid of one of the operating elements 701. The carriage 601 is moved by the drive motors 80, 82 controlled by the control device 661 to a first stored position, and, when the latter is reached, the laser 84 marks the replica of an assembly board 18 in accordance with the type-of-position data belonging to the position data, for example, forms a round or an angled hole in the replica of an assembly board. After marking the first stored position, the control device 661 moves the carriage 601 successively into the further, stored positions, which are marked in accordance with the type-of-position data.

As such, a replica of an assembly board 18 can be produced that, with respect to the circuit to be constructed, corresponds exactly to the master assembly board.

The data stored in the control device 66 can be transferred immediately to other control devices that belong to the control systems of devices according to FIG. 4. The data can also be stored temporarily on data media.

The configurations described can be modified in many and various ways. The type-of-position data and image or scene data can, for example, be displayed on the screen 741 so that, if the marking of the positions on the replica of an assembly board 18 is not carried out automatically by the carriage 601, an operator can apply the markings in accordance with the indicated type-of-position data. The type-of-position key 78 can be omitted, for example, so that the positions registered are marked in a uniform way on the replica of an assembly board.

The carriage according to FIG. 3 can be formed by a subassembly that is moved over the master assembly board 16 in a similar way to the mouse that is common in computers, it being possible for the click keys of the mouse to be used as trigger key and type-of-position key. It goes without saying that such a subassembly can be provided with a lens having a crosshair. The device according to FIG. 3 can be constructed as an automatically operating device, by supplementing position transmitters with motors, with which the carriage, controlled by the control device 66, can be moved for scanning the master assembly board 16. The carriage is, then, equipped with a sensor that detects the respective positions.

The carriage 601 according to FIG. 4 does not necessarily have to be provided with drive motors. Simple position transmitters can replace the drive motors 80 and 82, into which position transmitters are advantageously integrated so that they can be controlled accurately. The carriage 601 is, then, displaced by hand and a display on the screen 741 is used to show the direction in which the carriage 601 has to be moved so that a stored position is reached. Reaching the position is displayed.

In the configuration according to FIG. 4, the carriage 60 can, for example, contain a mechanical drilling device, which drills holes into the replica of an assembly board 18 at the appropriate positions. During the production of a hole or any other marking, the carriage 601 can be moved in a predetermined way by the control device 661. The carriage 601 can be provided with a device that merely marks the respective position optically, for example, using a printing element that applies symbols depending on the type of position to the replica of an assembly board.

The control program present in the control device 661 for controlling the motors 80 and 82 can be configured in a similar way to conventional control programs for controlling the movement of a component in an area. Actuating cylinders can form the motors 80 and 82.

The devices according to FIGS. 3 and 4, which together form a system, do not necessarily have to be physically separated but can be integrated so that the same device records the position data from a master assembly board and applies these position data, following replacement of the master assembly board by a replica of an assembly board, to the replica of an assembly board.

The carriage 601 of FIG. 4 can be equipped with additional welding, soldering, or other connecting devices, for connecting cables to connecting pins, for example. The mounting components can be of an extremely wide range of types and be simple holding pins, complicated multi-part hold-downs, and so on.

The base plates of the assembly boards can be, for example, perforated plates or plates with surfaces into which holes or threaded holes can be introduced in a straightforward way.

We claim:

1. A method for producing an assembly board replica, which comprises:
defining positions of mounting components for producing a master cable harness on a master assembly board;
registering the defined positions of the mounting components on the master assembly board with a copying device; and
transferring the registered positions of the mounting components to a replica of the master assembly board.

2. The method according to claim 1, which further comprises carrying out the transfer of the registered positions of the mounting components to the replica of the master assembly board with the master cable harness mounted on the master assembly board.

3. The method according to claim 1, which further comprises:
fitting the replica of the master assembly board in a physically fixed relationship with respect to the master assembly board; and
carrying out the transfer of the registered positions of the mounting components with an intrinsically rigid copying device movable in the same way relative to the master assembly board and the replica of the master assembly board.

4. The method according to claim 1, which further comprises:
storing the defined positions in a memory; and
reading out the defined positions and transferring the defined positions to the replica of the master assembly board.

5. The method according to claim 4, which further comprises adding type-of-position data to the defined positions.

6. The method according to claim 4, which further comprises:
defining type-of-position data related to the defined positions;
registering the type-of-position data; and
transferring the type-of-position data with the registered positions to the replica of the master assembly board.

7. A method for producing an assembly board replica for producing a cable harness duplicating a master cable harness for a motor vehicle, which comprises:
defining positions of mounting components for producing the master cable harness on a master assembly board;
registering the defined positions of the mounting components on the master assembly board with a copying device; and
transferring the registered positions of the mounting components to a replica of the master assembly board.

8. A device for producing a replica of an assembly board, comprising:
a master assembly board;
mounting components for an assembly of a master cable harness, said mounting components disposed on said master assembly board;
an assembly board replica for receiving other mounting components to produce a cable harness duplicating the master cable harness, said assembly board replica rigidly connected to said master assembly board;
an intrinsically rigid component movably guided relative to said master assembly board and said assembly board replica;
a copying device and a scanning device each disposed on said rigid component to have movement of said scanning device over said master assembly board correspond to movement of said copying device over said assembly board replica;
said scanning device connected to said copying device; and
said scanning device registering a position of a location on said master assembly board and transmitting said registered position to said assembly board replica through said copying device.

9. A device for producing a cable harness duplicating a master cable harness for a motor vehicle comprising:
a master assembly board;
mounting components for an assembly of a master cable harness, said mounting components disposed on said master assembly board;
an assembly board replica for receiving other mounting components to produce a cable harness duplicating the master cable harness, said assembly board replica rigidly connected to said master assembly board;
an intrinsically rigid component movably guided relative to said master assembly board and said assembly board replica;
a copying device and a scanning device each disposed on said rigid component to have movement of said scanning device over said master assembly board correspond to movement of said copying device over said assembly board replica;
said scanning device connected to said copying device; and
said scanning device registering a position of a location on said master assembly board and transmitting said registered position to said assembly board replica through said copying device.

10. A device for replicating mounting components assembling a master cable harness on a master assembly board to an assembly board replica having other mounting components and a cable harness duplicating the master cable harness, the assembly board replica being rigidly connected to the master assembly board, comprising:
an intrinsically rigid component movably guided relative to the master assembly board and the assembly board replica;
a copying device and a scanning device each disposed on said rigid component to have movement of said scanning device over the master assembly board correspond to movement of said copying device over the assembly board replica;
said scanning device connected to said copying device; and
said scanning device registering a position of a location on the master assembly board and transmitting said registered position to the assembly board replica through said copying device.

11. A system for producing a replica of an assembly board, comprising:
a master assembly board having mounting components at defined positions of said master assembly board, said mounting components assembling a master cable harness;
an assembly board replica;
a scanning device registering said defined positions and producing position data corresponding to said registered positions;
a storage device connected to said scanning device and storing said registered position data; and
a transfer device connected to said storage device and effecting transfer of said stored position data to said assembly board replica.

12. A system for producing a cable harness duplicating a master cable harness for a motor vehicle, comprising:
a master assembly board having mounting components at defined positions of said master assembly board, said mounting components assembling the master cable harness;
an assembly board replica;
a scanning device registering said defined positions and producing position data corresponding to said registered positions;
a storage device connected to said scanning device and storing said registered position data; and
a transfer device connected to said storage device and effecting transfer of said stored position data to said assembly board replica.

13. The system according to claim 11, including a position data producing device for producing position data corresponding to said defined positions of said mounting components, said position data producing device having:
position transmitters for generating position signals corresponding to a respective one of said defined positions;
a component displaceable over a surface of said master assembly board and interacting with said position transmitters;
a carriage connected to said component;
a storage device for storing the position data corresponding to said position signals; and
a triggering device controlling an action of reading the position data into said storage device when said carriage has reached a position corresponding to a position of one of said mounting components.

14. The device according to claim 13, including a type-of-position marking device connected to said storage device and storing type-of-position data into said storage device.

15. The system according to claim 11, including:
position transmitters for generating position signals corresponding to each respective position of said mounting components;
a component displaceable over an area of said assembly board replica and interacting with said position transmitters; and
a control device connected to said component and controlling a position of said component dependent upon said stored position data in said storage device.

16. The device according to claim 15, wherein:
said component is a carriage;
a drive motor is connected to said carriage and to said control device;
said drive motor moves said carriage respectively in one of two directions at right angles to one another; and
said control device controls said drive motor to move said carriage into positions corresponding to said stored position data.

17. The device according to claim 15, wherein:
said component is a carriage;
two drive motors are connected to said carriage and to said control device;
said drive motors each move said carriage respectively in one of two directions at right angles to one another; and
said control device controls said drive motors to move said carriage into positions corresponding to said stored position data.

18. The device according to claim 8, wherein:
said rigid component has:
a light source for illuminating a portion of said master assembly board; and
a camera for recording said illuminated portion of said master assembly board; and
a screen reproduces an image recorded by said camera.

19. The device according to claim 13, wherein:
said component has:
a light source for illuminating a portion of said master assembly board; and
a camera for recording said illuminated portion of said master assembly board; and
a screen reproduces an image recorded by said camera.

20. The device according to claim 8, wherein said rigid component is a marking device for marking locations on said assembly board replica corresponding to respective locations on said master assembly board.

21. The device according to claim 16, wherein said carriage is a marking device for marking locations on said assembly board replica corresponding to respective locations on said master assembly board.

22. The device according to claim 14, wherein said type-of-position marking device marks said assembly board replica dependent upon said type-of-position data.

23. The device according to claim 20, including a storage device connected to said scanning device and storing said registered position data, said marking device being a type-of-position marking device connected to said storage device and storing type-of-position data into said storage device, and said type-of-position marking device marking said assembly board replica dependent upon said type-of-position data.

24. A The device according to claim 8, wherein said master cable harness and said cable harness have cables and are fitted with circuit modules at least partly connected without plugs to ends of said cables and are fixed on said master assembly board by said mounting components.

25. The device according to claim 9, wherein said master cable harness and said cable harness have cables and are fitted with circuit modules at least partly connected without plugs to ends of said cables and are fixed on said master assembly board by said mounting components.

26. The device according to claim 10, wherein the master cable harness and the cable harness have cables and are fitted with circuit modules at least partly connected without plugs to ends of the cables and are fixed on the master assembly board by the mounting components.

27. The device according to claim 11, wherein said master cable harness has cables and is fitted with circuit modules at least partly connected without plugs to ends of said cables and are fixed on said master assembly board by said mounting components.

28. The device according to claim 12, wherein said master cable harness has cables and is fitted with circuit modules at least partly connected without plugs to ends of said cables and are fixed on said master assembly board by said mounting components.
